(19) United States
(12) Patent Application Publication
(10) Pub. No.: US 2012/0166746 A1
(43) Pub. Date: Jun. 28, 2012

(54) Security Device

(76) Inventors: Nissim Amar, Tel Aviv (IL); Silvia Ohana, Givatayim (IL)

(21) Appl. No.: 13/337,135

(22) Filed: Dec. 25, 2011

Related U.S. Application Data
(60) Provisional application No. 61/427,195, filed on Dec. 26, 2010.

(51) Int. Cl. G06F 12/14

(52) U.S. Cl. 711/163; 711/E12.098

(57) ABSTRACT

A security device for securing secondary data storage devices having different levels of data security. The security device has an access to a plurality of primary and secondary storage devices, switches configured to separately enable and disable read and write operations to each of the plurality of storage devices, where at least two secondary storage devices cannot have their write access enabled at the same time. Further, the security device has a control circuit adapted to control the switches, and software that controls the switches in a manner that is transparent to the user. In one embodiment the operating system of the computing system resides on a separate storage device that is write protected when switching to a low level security storage device, the computing system and its operating system are ACPI compliant, and ready ACPI states are used in conjunction with switching the primary storage.

### CROSS REFERENCE TO RELATED APPLICATIONS

This application claims the benefit of the filing date of: U.S. provisional patent application Ser. No. 61/427,195, entitled “Securing Storage Devices”, filed on Dec. 26, 2010, the disclosure of which is incorporated herein by reference.

### FIELD

The present invention relates to the field of information security. More particularly, the invention relates to a method and device for securing data that is exposed to access and corruption by external sources or other vulnerabilities and hacks.

### BACKGROUND

Having the capability to connect to a network, such as the internet or other information systems, many times is essential to the daily work operations. Therefore, today most computing systems are connected to a network or other external data source (herein NET-data/drive), such as the internet, and thus are vulnerable to loosing confidentiality of their data as hackers may gain access to their system and obtain confidential information such as trade secrets and propriety information. These computing systems are also vulnerable to malicious attacks such as viruses and Trojan horses, attacks that corrupt their data, and attacks that leave their data accessible to the outside network.

It is common today to protect data that is exposed to external sources of corruption, access, and other hacks, by using anti-virus and firewall programs, or by passing the data via different network paths. In those configurations the sensitive data (herein CONF-data/drive) sits on a storage medium, hard drive for example, that physically allows the capability to read, write and thus access or corrupt the data on it, and the various software schemes, such as anti-viruses and firewalls, prevent this from happening some of the time. The limitation of anti-virus, firewall programs, and software configured network path routers, is that they can be jeopardized by another program. Men created software can be jeopardized by men created software.

Prior art presents embodiments in which NET-data and CONF-data are stored on different data storage devices and each of the data storage devices also contains an operating system. Some embodiments also specify a reset or boot sequence upon switching between the storage devices. The disadvantages of such a configuration are that licenses for each additional copy of operating system and applications are costly, the additional memory space is wasteful, and undesirable differences in operating system versions shall always exist. From software point of view, this is essentially equivalent to having two computing systems. Engaging in a boot sequence upon switching is timely. Some prior art requires the user to switch manually between storage devices, a process that is unacceptable to some users, and tedious to most. Other prior art requires that the storage devices shall be made of the same memory media such as a magnetic hard drive with several platters, where each surface of a platter may designate a separate storage device. The versatility of memory media, such as fast spinning for large database applications, flash memory for operating system storage to gain faster access time, or standard low cost SATA hard drive for user NET-data, may be more suitable for large organizations that require maintaining many computing systems.

It is an object of the present invention to provide a method and device capable of overcoming many of the limitations of existing data security systems and better protect data stored on a computing system.

### SUMMARY

A program controlled security device which enables for access a plurality of disjoint secondary data storage spaces in a manner that is transparent to the user. The disjoint data storage spaces are classified into data storage devices, some contain high-security data and some low-security data. The security device may also comprise a plurality of main-memory disjoint storage spaces. In one embodiment switching between high-security and low-security data devices is done in a similar manner that a single pole double through switch selects either one device for access or the other, but never both at the same time. Furthermore, upon switching between the high security and low security storage devices, the disk-image of the operating system main-memory is copied to the device from which it is disengaged, then main-memory is erased, then the disk-image is loaded onto the main-memory from the device to which it is engaged to. The copy and load operations of the disk-image are done from main-memory device to a volatile fast access memory storage device (may or may not be similar to the main-memory device), so that access time is minimal.

In one embodiment the security device uses a System Sleeping State between transitions. One may decide to use the System Power State where the microprocessor looses power, which causes all microprocessor state and catch content to be lost. Then handle the disk-image copy-erase operations of main-memory, switch access to the other secondary data storage device, handle the disk image load operation, and wake the system, that is, recover to normal operation.

The security device may comprise switches and control circuitry that are adapted in a similar manner as a single pole double through (SPDT) switch for enabling memory access operations to at least two storage devices. We designate these two storage devices CONF-data for high security level confidential data, and NET-data for low security level data. When NET-data is available for read/write, then CONF-data is not available; when CONF-data is available for read/write then NET-data is not available. That is, data access is available either to NET-data or to CONF-data, one at a time. One may decide to protect CONF-data only for write operation, and allow NET-data to read CONF-data. This can also be achieved using one signal and its inverted signal to control the read/write operations. Main-memory is assigned for these two storage devices. The program that automatically controls the switching among storage devices does so by identifying the user selected file or program with its physical storage location on one of the disjoint storage spaces, and switching the secondary memory operation to the appropriate storage device where that program or file resides, as well as taking care of the primary-memory operations.

The security switching device may include some or none of the storage devices and main-memory devices. When not all storage devices or main-memory devices are included then the security device provides connectors and/or means to connect to the missing devices.

Other features of the security switching device may include connecting the data path of the network access of the computing system only when the security device allows memory access to NET-data, be it a hard wired network path or wireless data path; allowing USB access to each of the storage devices in a manner that keeps their isolated topology; restricting or limiting the switching activity to allow NET-access to some frequency or time of day; adding DMA control circuitry to allow independent basic memory operations to NET-data when NET-data is connected to the internet and not connected to, or cannot fully access, CONF-data; adding high-burst main memory erase, copy and load circuitry to automate disk-image copy, load and erase operations between.

Other features and benefits that characterize embodiments of the invention will become apparent as the description proceeds.

### BRIEF DESCRIPTION OF THE DRAWINGS

FIG. 1 illustrates a simplified block diagram of an exemplary computing system.

FIG. 2 illustrates a simplified diagram of data storage devices under one embodiment.

FIG. 3 illustrates a simplified diagram of data storage devices under yet another embodiment.

FIG. 4 illustrates a simplified block diagram of an exemplary computing system that is secure by security device under one embodiment.

FIG. 5 illustrates a simplified block diagram of an exemplary computing system that is secure by security device under yet another embodiment.

FIG. 6 illustrates a simplified block diagram of an exemplary computing system that is secure by security device under yet another embodiment.

### DETAILED DESCRIPTION

Reference will now be made to several embodiments of the present invention, examples of which are illustrated in the accompanying figures. The figures depict embodiments of the present invention for purposes of illustration only. One skilled in the art will readily recognize from the following description that alternative embodiments of the structures and methods illustrated herein may be employed without departing from the principles of the invention described herein.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components. The example appearance and terminology as depicted and described herein, are intended to be illustrative and exemplary, and in no way limit the scope of the invention as claimed.

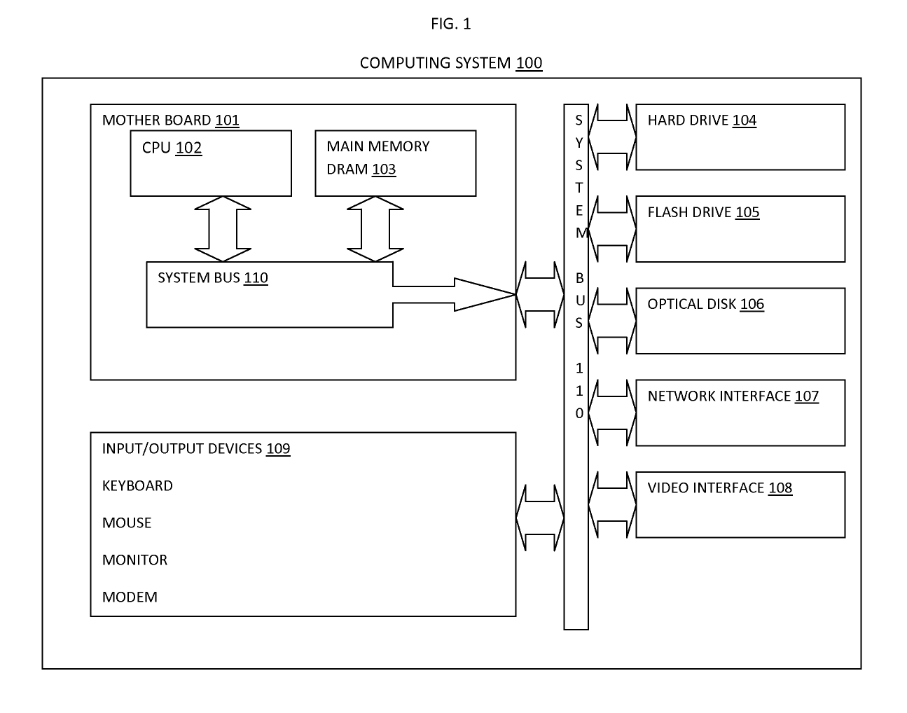

FIG. 1 illustrates an exemplary simplified block diagram of a computing system 100 that includes a mother board 101, a Central Processing Unit (CPU) 102, random access volatile main-memory (DRAM) 103, non-volatile memory for mass storage such as magnetic storage hard drive 104, and flash drive 105, optical disc 106, network interface card 107, video interface card 108, and other input and output devices 109 such as keyboard, pointing device, modem, and display monitor. These devices communicate and connect via system bus 110.

The present invention relates to a computing system that allows access to a low security level or external data source, such as network data or the internet (herein NET-data/drive), that may jeopardize high security level or confidential data on the computing system (herein CONF-data/drive).

In this document the words enable or disable read and/or write memory operations include controlling access to the data channel, to chip enable, to chip select, or some address lines that inhibit or allow access to a memory block so that memory access permissions are realized.

Embodiments of the disclosure separate the high security level or confidential data (CONF-data) and the low security level data (NET-data) on a plurality of disjoint data storage spaces; on separate memory storage devices that may connect to the computing system, or on the same memory storage device by providing a control circuit or mechanism to select one of a plurality of disjoint secondary data storage spaces.

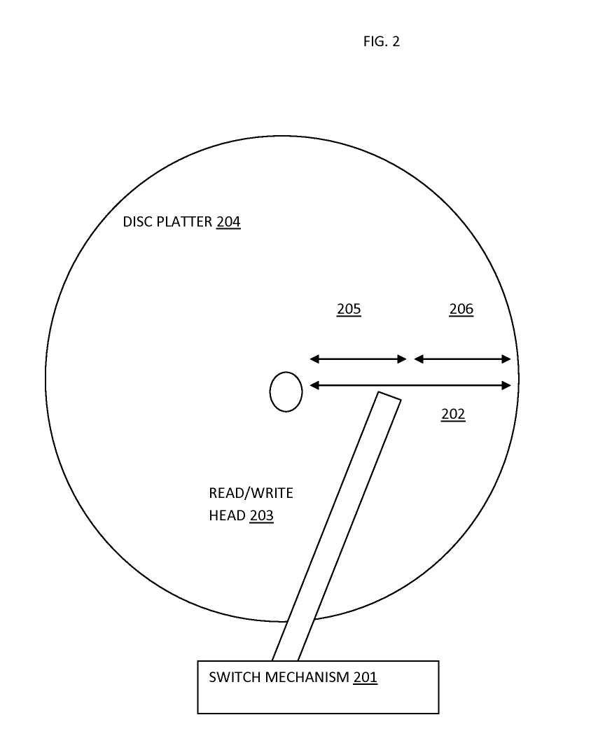

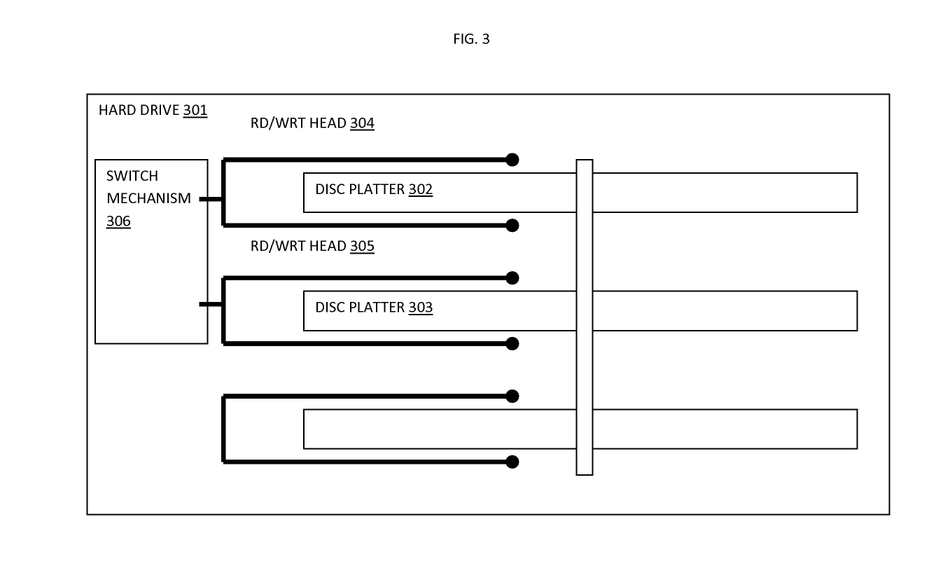

FIG. 2 illustrates a switch mechanism 201 for limiting the span 202 of one read/write head 203 over a memory storage disc platter 204 to allow data access to disjoint memory storage spaces 205, 206. FIG. 3 illustrates one magnetic media hard drive 301 with several magnetic media disc platters 302, 303 and multiple read write heads 304, 305 that are switched by switch mechanism 306 to allow data access to disjoint memory storage spaces 302, 303. These embodiments illustrate the case when one data channel is used to access several disjoint memory storage spaces. The data channel consists of the memory data bus and all control signals that are required in order to access all memory available functions, such as read, write, erase, select lines, and clocks, for that memory storage space.

We categorize or call the disjoint memory storage spaces as disjoint storage devices. In another embodiment a block of sequential memory storage addresses of a storage device is separated into two disjoint memory devices by hardware inversion of the Most Significant Bit (MSB). A storage device may consist of a non contiguous block of memory addresses. Storage devices may include volatile and non-volatile memory storage media, or a combination herewith, such as magnetic, flash, solid state and the like. Embodiments of the security device may include no storage devices, one storage device, or more than one storage device. When an embodiment includes less than two mutually disjoint data storage devices, it shall include means to connect to such storage devices.

Each computing system includes primary storage, also called main-memory or internal memory, herein main-memory, primary-memory, RAM, SRAM or DRAM. The main-memory device is the only one directly accessible to the CPU. The CPU continuously reads instructions stored there and executes them as required. Any data actively operated on is also stored there in uniform manner. The main-memory device is essential to the operation of the operating system and is usually in the form of volatile static or dynamic random access memory (RAM, SRAM, or DRAM).

Use of common dynamic power management features best describes the operations done between switching when high and low security storage devices. In computing, the Advanced Configuration and Power Interface (ACPI) specification provides an open standard for device configuration and power management by the operating system. ACPI specification is central to Operating System-directed configuration and Power Management (OSPM), a term used to describe a system implementing ACPI, which removes device management responsibilities from legacy firmware interfaces. ACPI requires that, once an OSPM-compatible operating system has activated ACPI on a computer, it then takes over and has exclusive control of all aspects of power management and device configuration. The OSPM implementation must expose an ACPI-compatible environment to device drivers, which exposes certain system, device and processor states. Of interest are the System Sleeping States which subdivides into the four states S1 through S4. Other states, such as Core States, may also be of interest. With each successive sleep state, from S1 to S4, more of the computer is shut down. All ACPI-compliant computers shut off their processor clocks at S1 and lose system hardware context at S4.
S0: The active state of the system, that is, normal operation.
S1: All processor caches are flushed, and the CPU(s) stop executing instructions. Power to the CPU(s) and main-memory contents (RAM) is maintained. Processor clock is off and bus clocks are stopped.
S2: CPU powered off, that is, CPU state and cache contents are lost.
S3: Commonly referred to as Standby, Sleep, or Suspend to RAM. CPU powered off and chipset looses context. Main-memory (RAM) is maintained.
S4: Commonly referred to as Hibernation or Suspend to Disk. All content of main-memory (RAM) is saved to non-volatile memory such as a hard drive, and is powered down. CPU and other hardware state is written t non-volatile memory.
   System Sleeping States such as ACPI states S1 to S4 are ideal for implementations of embodiments of the present invention. For example, the transition of switching memory access between a high security and low security storage devices can set the computer to ACPI state S2; copy main-memory to RAM filespace that is assigned for the high security storage device; erase main-memory; set switching means to disengage data access from the high security storage device, and allow data access to the low security storage device; load disk-image onto main-memory from RAM filespace that is assigned for the low security storage device; and finally wake the computing system, that is, set it back to ACPI state S0. In a minimal configuration there is no RAM filespace assigned for high security and low security storage devices, and the disk-image is copied to and loaded from the secondary storage devices respectfully. When RAM is used as filespace, then its critical characteristics such as access time need be better than that of secondary storage, but not necessarily as fast as primary storage. Alternately, in a minimal embodiment when there is only the main-memory of the operating system and no RAM filespaces, similar steps that take place in the ACPI state S4, where CPU and other hardware states are written to or loaded from the secondary storage devices, may be used. The time it takes to “wake up” from state S4 to state S0 is longer.

In another embodiment each secondary storage device is paired with a dedicated primary main-memory storage device, such as volatile RAM. When access is allowed for a selected secondary storage device, then its paired primary main-memory storage device is enabled for data access by the computing system's CPU, and when access is disabled for a selected secondary storage device, then its paired primary main-memory storage device is disabled for data access by the computing system's CPU. For example, switching between CONF-data and NET-data, computing system goes to Sleeping State S2, disengages the main-memory assigned for CONF-data, and engages the main-memory assigned for NET-data to work directly with the computing system's CPU. Both main memory content is retained, but CONF main-memory is not accessible by the CPU, and at the same time data access is disengaged from CONF secondary storage device and engages to NET secondary storage device.

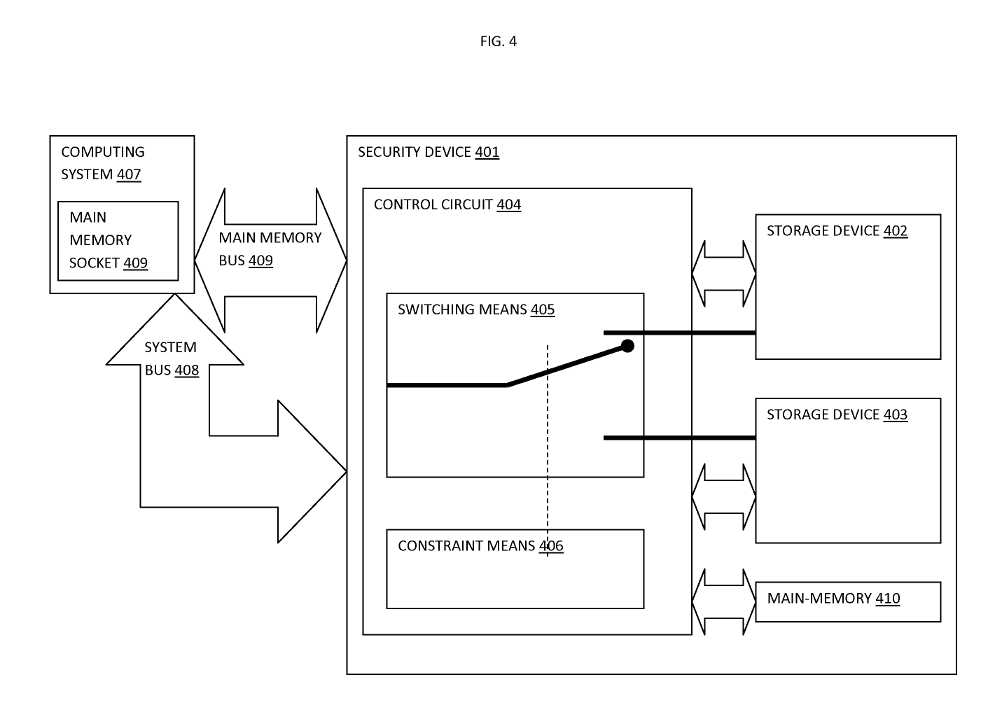

FIG. 4 illustrates a security device for a data storage system 401 under one embodiment. Security device 401 includes storage device 402 dedicated for CONF-data and the operating system, and storage device 403 dedicated for NET-data, a program controlled control circuit 404 that includes hardware switching means 405. These hardware switching means shall be designed in a similar manner that a single throw double pole connects to two states, so that when one switching state is engaged the other switching state is disengaged. Switching means may be implemented by using SPST relays, analog switches such as the 4016 IC, or digital enable signal inverted where the same signal is used to enable one storage device and that same signal inverted is used to disable another storage device. Hardware switching means 405 have two possible positions. In one position switching means 405 allow full access (read/write) to the data path of storage device 402, and disallow access to storage device 403. In the other position switching means 405 allow full access (read/write) to the data path of storage device 403, and disallow write data access to storage device 402. Before and after switching between storage devices 402 and 403 the main-memory 410 disk-image gets copied and loaded, and main-memory 410 is erased between the copy and the load of the disk-image. In detail: in the default position full data access is available to storage device 402, and no data access is available to storage device 403. The user does his work. When the user accesses a file or a program that resides on storage device 403, the computing system performs tasks similar to ACPI state S4; the main-memory disk-image is copied onto storage device 402, main-memory 410 is then erased, for example, by interruption of power or refresh circuitry, the CPU state and cache content are flushed, then switching means disconnects write access for storage device 402 and connects storage device 403 for full data access, then the computing system performs similar actions as “wake up” sequence; the main-memory 410 is loaded with a disk-image that was stored on storage device 403. Storage devices 402 and 403 may contain some minimal default initial disk-image. Main-memory control circuitry may sit as a part of main-memory device 410 so that most of the time the bus of main-memory is close to the computing system CPU, and only between switching data is transferred on main memory bus 409. Alternately, use of the ACPI System Power States as described before may be used. Switching means 405 switching functionality may be limited by hardware constraints means 406. Hardware constraint means 406 may limit the switching functionality to several times a day, to allowed switching during work hours only, or to slow switching rate to a human pace such as once per second. Control circuit 404 is program controlled and is connected to a computing system 407 via system bus 408. Program control (herein AUTO_SW_ALGO) of the switching means is done in a manner that is mostly transparent to the user, by employing an algorithm that identifies user accessible programs and files or their shortcuts with their storage locations on the storage devices, that is, either on NET-data or on CONF-data. When a user selects a file or a program using regular methods such as a mouse-click, touch-screen, tab selection or voice activation on a shortcut icon or active window, the AUTO_SW_ALGO identifies where the selected file or program resides and sends commands to the control circuit to activate the switching means to allow data access to either the NET-data or CONF-data automatically.

In this document the words “switching means” mean the use of switches, where a switch is a device, including mechanical, electrical, electronic, optical, and such, which opens or closes circuits, makes or breaks a path, enables or disables signals, or selects or deselects paths or circuits.

In another embodiment the disk-image is copied to and loaded from dedicated memory of similar size and faster access time than secondary storage. Each such memory is assigned to each of NET-data and CONF-data, and they cannot access each other for read or for write operations. Such an embodiment may include fast, burst or mirror, copying and loading of memory blocks, and thus maintain rapid switching among devices. In this embodiment the additional fast-access memory is used as filespace, not as main-memory to interact with the computing system's CPU directly.

In another embodiment when NET-data is from an external source such as the internet, additional switches connect the network data path when full data access is allowed for NET-data, and break the network data path when no data access is allowed to NET-data.

In another embodiment USB access is available to each of the storage devices where each USB allows full access only to one device, and does not modify the topology.

In another embodiment the security device shall provide user set states that set the storage devices access to be achieved. In other words the security device will include hardware means that may be set initially, to set possibilities of disjoint or different read/write states for accessing the storage devices. Some examples of such hardware means may include DIP switches, jumpers, an EPROM, or Programmable Array Logic. An example of initially programmable states is: in one state have the OS-drive set for read only at all times, and in another state set the OS-drive for read/write when accessing the CONFIDENTIAL-data and read-only when accessing the NET-data. Such user set states are programmed upon installation and should be rarely modified. These user states cannot be repeatedly modified by programming software only during normal operation so that unwanted hacking cannot happen. They may be one-time programmed and “burned” to some set configuration, or programmed and require some hardware switching or jumping to return to normal operation, for example.

In another embodiment the OS-drive can be stored on faster access time memory storage media, of minimum size, to contain only the operating system files. For example, store the operating system on flash memory of size 30 GB to 256 GB. Flash memory has faster read access time than magnetic hard drives. The OS-drive may be set for read only, where an outside switch or jumper enables it for write also. In that case hacking or tampering is further hindered.

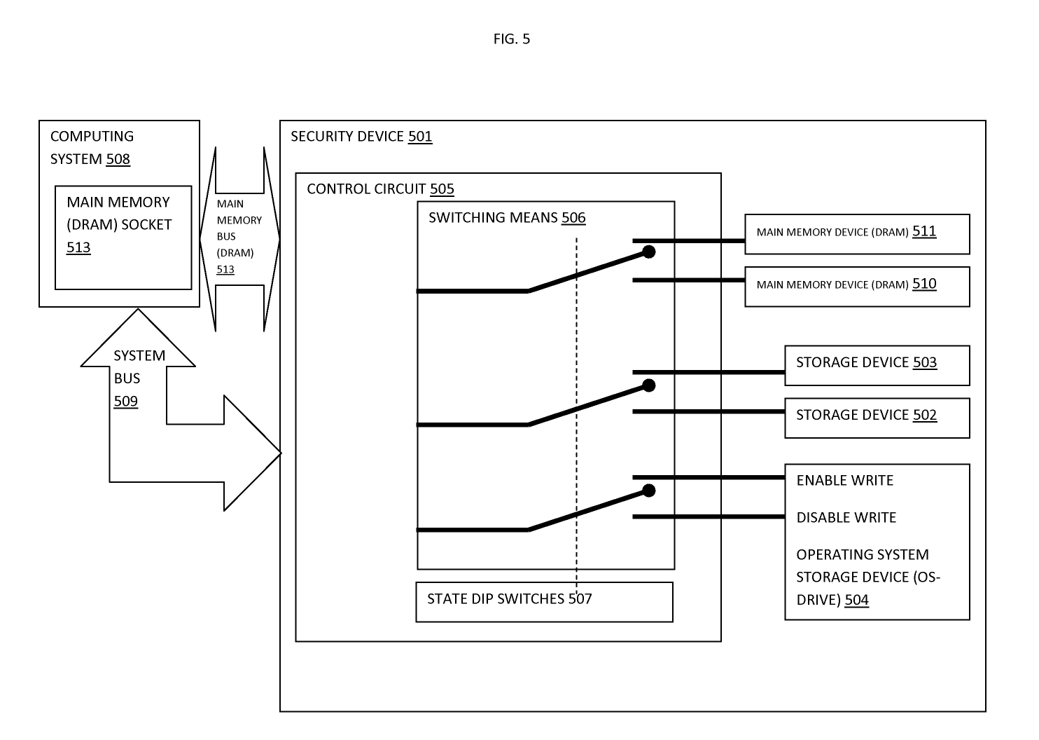

FIG. 5 illustrates another embodiment of the present invention. Security device 501 includes storage device 502 dedicated for NET-data, storage device 503 dedicated for CONF-data, storage device 504 dedicated for the operating system (OS-data), a program controlled control circuit 505 that includes switching means 506. Switching means 506 have two possible positions. In one position switching means 506 allow full access (read/write) to the storage device 502, disallow access to storage device 503, disable write access (that is, allow read only access) to storage device 504. In the other position switching means 506 allow full access (read/write) to the data path of storage device 503, disallow access to storage device 502, enable write access (that is allow read and write access) to storage device 504. Switching means 506 switching functionality of allowed read and write states to storage devices and main-memory devices are set via STATE DIP SWITCHES 507. Control circuit 505 is program controlled and is connected to a computing system 508 via system bus 509.

Security device 501 has point to point connections from computing system 508 MAIN MEMORY SOCKET 513 via MAIN MEMORY BUS 513 to SECURITY DEVICE 501, two MAIN MEMORY DEVICES 510, and 511, and additional switching means that operate in conjunction with secondary storage devices' switching means. When SWITCHING MEANS 506 enables for data access STORAGE DEVICE 503, MAIN MEMORY SOCKET 512 data path allows access to MAIN MEMORY DEVICES 511 only, and when SWITCHING MEANS 506 enables for data access STORAGE DEVICE 502, MAIN MEMORY SOCKET 512 data path allows access to MAIN MEMORY DEVICE 510 only. MAIN MEMORY DEVICES 510 and 511 maintain their data even when not accessible, and are mutually exclusive disjoint data storage spaces; they may be connected each to a separate available socket on COMPUTING SYSTEM 508 and have the chip select inputs hardwired to result the data access permissions described herein, or toggle the Most Significant Bits (MSB) of one main-memory device in order to split it to two or more disjoint mutually exclusive data storage spaces for main-memory. Upon initial boot both devices 510 and 511 may contain the same default disk image or some minimal default disk-image. Between switching of devices the CPU state and cache contents may be erased. The clipboard file locations may be specified to reside on STORAGE DEVICES 502 and 503, but not on the OS-drive 504, and thus ensure that the CONF-data is completely protected. Even cut and paste operations cannot be transferred from NET-data to CONF-data, or vice-versa. Switching means that operate in a SPDT manner guarantees that there can never be a state where CONF-data is open for access by NET-data. This indeed is a grave advantage considering the nature of commercial espionage that sometimes covertly seeks access to client database, hiring needs, contract bids, product files, credit card information and the like. Yet another embodiment may set the OS-drive 504 for read only after boot, without having the possibility to modify or allow write access for the OS-drive. Again ready ACPI States may be used. ACPI States S1 or S2 are ideal here. Note that in this embodiment the main-memory devices are used as the main memory to interact directly with the computing system CPU, and switching time between devices is rapid. Hence main memory devices 511 and 510 must be compatible and have similar critical characteristics such as access time as the main memory specifications needed for the computing system 508.

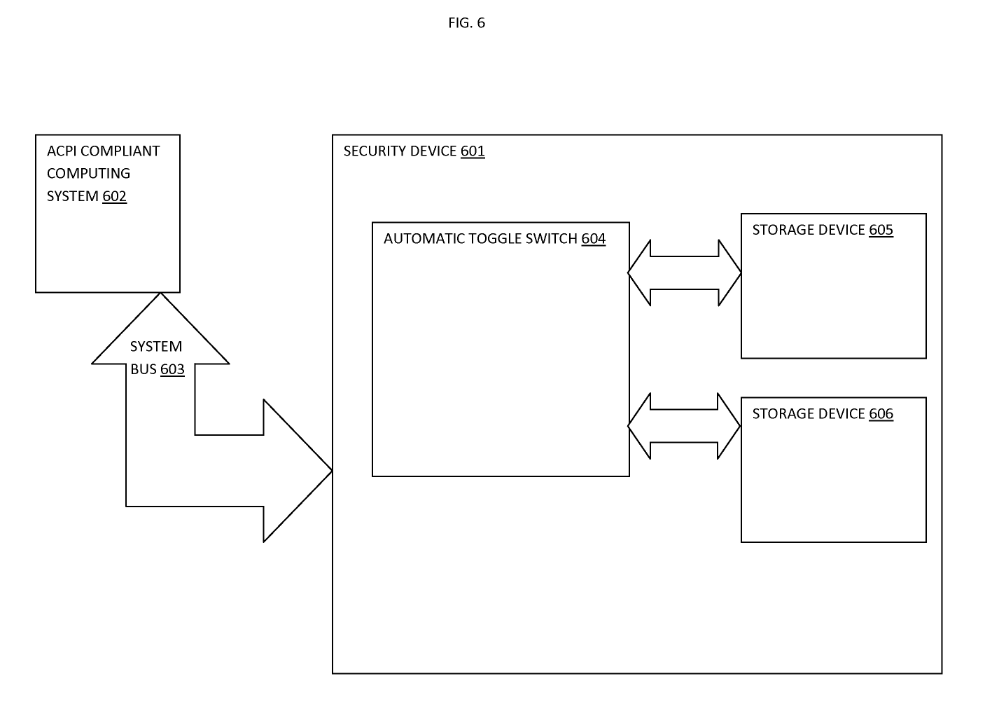

In yet another embodiment the security device simply toggles data access between two storage devices upon receiving interruption of some signal such as device enable or device power. In FIG. 6 an ACPI compliant COMPUTING SYSTEM 602 is connected to SECURITY DEVICE 601, via SYSTEM BUS 603. SECURITY DEVICE 601 consists of AUTOMATIC TOGGLE SWITCH 604 selecting either STORAGE DEVICE 605 or STORAGE DEVICE 606 for full data access upon certain trigger such as power interruption. Only one of STORAGE DEVICES 605 or 606 is available at one time. In a minimal configuration user selects ACPI Hibernate State S4 to toggle between storage devices. In this configuration the computing system may have its operating system and main application programs such as Microsoft Office on an additional storage device, OS storage device, that is write protected at all times. Alternately SECURITY DEVICE 601 may toggle the OS storage device write enable when say storage device 605 data access is enabled and disable the OS storage device for write access when storage device 606 data access is enabled. This is a minimal component configuration that guarantees safety of data. Future evolved ACPI states performing the essentials of copying the disk-image of the primary-storage device to the secondary-storage device, erasing the primary storage content and CPU catch, and loading the disk-image from secondary storage to primary storage, may be used.

The security device may comprise direct memory access (DMA) control circuitry to allow file transfer even when a storage device is not connected to said computing system. For example, one may start downloading a file from the internet and continue to work safely on CONF-data, while NET-data is completely disengaged from data access to CONF-data.

Future memory storage media such as hard drives may be designed to include several storage devices, several main-memory devices (DRAM) and the control circuit that includes the switching means in one unit as part of memory media controller circuitry, allowing for better efficiency of physical size and power. Such a device shall be ideal for the security device of the present invention.

Constraint means feature may set for example slow switching means to a frequency of at most once per second between 9 AM to 5 PM, Monday to Friday, and set a maximum of 200 switching throws per day. Another constraint means feature may detect fast switching between drives, faster than that a human can do, and lock the switch and present a warning. This is best done via hardware so that the feature cannot be hacked or overridden via software. Switching can be delayed using timers, counters, latches or slow responding circuitry. The program that controls the switching can also keep a log of the switching activity and the file location that is accessed.

According to the present invention, the control circuit is controlled by a dedicated program, AUTO_SW_ALGO, that keeps or identifies shortcuts of addresses of all programs and files that reside on the computing system and sets the correct switching state in a manner that is transparent to the user. In other words, the security device switches the read/write states, and data paths, of the storage devices and main-memory devices according to the location of the program currently selected by the user, e.g., whether the selected program is a web browser that required a direct access to the Internet, or a local Word document of a proprietary patent application. When a user selects a program or a file via a mouse click, touch-screen, or other methods such as voice activation, or when a user selects or brings into focus an active window, the program controlling the control circuit sets the correct storage device access and main-memory access according to the location of the user file or program selected, or according to the content of the active window selected. For example, use user32.dll on Windows to identify the storage device location of the program that is displayed in the active window selected by the user. The switching of the storage device access and the main-memory access is completely transparent to the user. The program controls the switching dynamically and automatically. The program may use ready ACPI States. Other features of the dedicated program may include: initial user programmable states and disjoint states settings, setting read, write or data path access to each of the primary and secondary storage devices, keep log files of switching activities, keep track of time and pattern of switching (frequency and time of day), or lock too fast or too many switching.

For storage devices one may use SATA drives that support hot swapping and hot plugging so that the storage devices can be easily made readily available when they are enabled for read/write without interrupting the operation of the computing system. USB flash memory is another example of a storage device that is removable or hot plugged.

The security device of the present invention may be used on any computer that uses any operating system, and on standalone microprocessor devices that are operated on some embedded or very small operating system and need to access safe data and unsafe data from distinguishable sources. Data information may be communicated via hard wiring or via wireless communication.

The functions of the security device and the corresponding dedicated program as described herein may be performed by executable code and instructions stored in computer readable medium and running on one or more processor-based systems. However, state machines, and/or hardwired electronic circuits can also be utilized. Further, with respect to the example processes described herein, not all the process states need to be reached, nor do the states have to be performed in the illustrated order. Further, certain process states that are illustrated as being serially performed can be performed in parallel. Similarly, while certain examples may refer to a Personal Computer (PC) system, other computer or electronic systems can be used as well, such as, without limitation, a tablet, laptop, and the like.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

What is claimed is:

1. A security device and method comprising:
one or more data channels for accessing a plurality of disjoint non-overlapping secondary memory storage spaces, the plurality of storage spaces classified into a plurality of storage devices;
switches configured to separately enable and disable read and write data access operations to each of said storage devices, wherein write operation for at least two storage devices cannot be enabled at the same time;
a control circuit adapted to automatically and dynamically provide memory access operations to said plurality of storage devices;
software working in conjunction with said control circuit to automatically and dynamically provide memory access operations to said plurality of storage devices.

2. The security device of claim 1 wherein said plurality of storage devices comprise a first storage device assigned for high level security (HLS) data, and a second storage device assigned for low level security (LLS) data, wherein said control circuit and said software further adapted to perform the following steps of operation when alternating write access permissions between first and second storage devices: (i) computing system status is: write access is enabled for first storage device and disabled for second storage device; (ii) the user selects a program or a file that requires write access to said second storage device; (iii) the computing system's primary-memory's disk-image is copied onto said first storage device; (iv) said primary-memory is erased; (v) said switches disable write access to said first storage device and enable write access to said second storage device; (vi) pre-saved disk-image is loaded from said second storage device to said primary-memory; (vii) normal operation resumes. Switching write access between second storage device to first storage device is done in a similar manner.

3. The security device of claim 2 further comprising two disjoint non overlapping memory storage spaces of faster access time than said storage devices, classified as primary-memory-filespace devices, and each assigned for HSL storage device and LSL storage device. Said primary-memory-filespace devices are to contain the respective disk-image that is copied and loaded between switching of write access permissions of said storage devices, in place of copying and loading the respective disk-image on said storage devices.

4. The security device of claim 1 further comprising: at least one additional memory storage space with critical parameters compatible with the computing system's primary-storage-device, together with the computing system primary-storage classified as primary-storage-devices and assigned each to HSL storage device and LSL storage device; at least one data channel configured to provide a data path between said computing system's CPU and one of said primary-storage-devices; wherein said control circuit and said software are further adapted to perform the following steps of operation when alternating write access permissions between said storage devices: (i) computing system status is: write access is enabled for first storage device and disabled for second storage device, and said first primary-storage-device is enabled and works as the computing system primary memory, and second storage device is disabled for access yet its memory content is retained; (ii) the user selects a program or a file that requires write access to said second storage device; (iii) said switches disable write access to said first storage device and enable write access to said second storage device, and at the same time disable data access of said first primary-storage-device and enable data access of said second primary-storage-device in a manner that second primary-storage-device works as computing system's primary storage, yet said first primary-storage-device data content is retained.

5. The security device of claim 2 comprising an additional storage device wherein the computing system's operating system resides, and is available for read only upon enabling write access to said low security level storage device.

6. The security device of claim 3 comprising an additional storage device wherein the computing system's operating system resides, and is available for read only upon enabling write access to said low security level storage device.

7. The security device of claim 4 comprising an additional storage device wherein the computing system's operating system resides, and is available for read only upon enabling write access to said low security level storage device.

8. The security device of claim 5 wherein said switches concurrently disable or enable both read and write operations of the same device when switching data access between HSL and LSL storage devices, in a manner that read and write is available for one of HSL and LSL storage devices and not available for the other.

9. The security device of claim 6 wherein said switches concurrently disable or enable both read and write operations of the same device when switching data access between HSL and LSL storage devices, in a manner that read and write is available for one of HSL and LSL storage devices and not available for the other.

10. The security device of claim 7 wherein said switches concurrently disable or enable both read and write operations of the same device when switching data access between HSL and LSL storage devices, in a manner that read and write is available for one of HSL and LSL storage devices and not available for the other.

11. The security device of claim 2 using an ACAPI compliant operating system, wherein said software makes use of one of said ACAPI as a preparation to switching between said storage devices.

12. The security device of claim 3 using an ACAPI compliant operating system, wherein said software makes use of one of said ACAPI as a preparation to switching between said storage devices.

13. The security device of claim 4 using an ACAPI compliant operating system, wherein said software makes use of one of said ACAPI as a preparation to switching between said storage devices.

14. The security device of claim 1 wherein said switches that enable and disable the read and write data access operations of said storage devices are user programmable upon initialization or setup but can never be modified via software only during normal operation.

15. The security device of claim 1 wherein said software is controlling said security device in a manner that is completely transparent to the user and runs independently in the background in such a manner that accessing any file or program on said computing system is done as it is done when said switching device is not a part of said computing system.

16. CLAIM-BREAK-OR-MAKE-NETWORK-CONNECTION The security device of claims 2 wherein when said control circuit allows full data access to one of said disjoint storage devices, said control circuit connects a data path to a network access connection and when said control circuit disallows data access to same said disjoint storage device, said control circuit disconnects the said data path to network access connection.

17. CLAIM 9 USB-EXTERNAL-ACCESS: The security device of claims 2 wherein said storage devices are accessible each by the user via user accessible memory data channel and connector. Said user accessible memory data channel does not modify the topology of said storage devices.

18. CLAIM CONSTRAINTS: The security device of claim 1 wherein said device further comprise constraint means adapted to limit the frequency and pattern of switching activity of said switches.

19. A security device comprising:
one or more data channels for accessing a plurality of disjoint non-overlapping secondary memory storage spaces, the plurality of storage spaces classified into a plurality of storage devices;
switches separately enable and disable read and write data access operations to each of said storage devices; wherein said switches automatically toggle between two configurations of read and write permissions to said plurality of storage devices. Said security device is to be connected to an ACPI compliant operating system having a state essentially similar to a Hibernate State, and where the toggling occurs upon receipt of signal generated by said operating system handling said State taking the following steps: (i) user selects file on disengaged storage device; (ii) State Hibernate is initiated, in which disk-image of primary-memory is copied to engaged storage device then power to engaged storage device is interrupted; (iii) said switches receive interruption of at least one signal and toggle to disable first read/write configuration and enable second read/write configuration of plurality of storage devices; (iv) computing system “wakes” from Hibernate State loading the disk-image onto primary-memory from toggled enabled storage device.

20. The security device of claim 19 further comprising software working in conjunction with said control circuit to automatically and dynamically provide memory access operations to said plurality of storage devices, wherein said software is controlling said security device in a manner that is completely transparent to the user and runs independently in the background in such a manner that accessing any file or program on said computing system is done as it is done when said switching device is not a part of said computing system.
